(19) United States
(12) Patent Application Publication
(10) Pub. No.: US 2018/0099426 A1
(43) Pub. Date: Apr. 12, 2018

(54) Ergonomic Cutting Tool

(71) Applicant: Brian Richie Designs Incorporated, Newport Beach, CA (US)

(72) Inventor: Brian Ritchie, Laguna Beach, CA (US)

(21) Appl. No.: 15/726,776

(22) Filed: Oct. 6, 2017

Related U.S. Application Data
(60) Provisional application No. 62/405,653, filed on Oct. 7, 2016.

(51) Int. Cl. B26B 13/20; B26B 13/16; A01G 3/02

(52) U.S. Cl. CPC B26B 13/20; A01G 3/02; B26B 13/16

(57) ABSTRACT

An ergonomic cutting tool configured to improve convenience and reduce pain and fatigue from repetitive cutting or trimming over an extended period of time. The tool includes a cutting component and a handle component joined to the cutting component, the handle component including a first handle and a second handle. The tool also includes a spring component coupled to the handle component and arranged to bias the handle component to an open position and a flexible member joined to an exterior surface of either of the first handle and the second handle to form a space therebetween, wherein the flexible member is arranged to enable removable retention of one or more of a user's fingers between the flexible member and the handle to which it is joined. An optional flip release section of the handle with the flexible member allows for expansion of the space therebetween.

### BACKGROUND OF THE INVENTION

### 1. Field of the Invention

The present invention relates to trimming and cutting tools such as trimmers, clippers and scissors but not limited thereto. More particularly, the present invention relates to such cutting tools suitable for repetitive use over an extended period of time. Still more particularly, the present invention relates to cutting tools having an ergonomic configuration.

### 2. Description of the Prior Art

There are a wide variety of cutting tools that can be used to make small cuts and large cuts. They can be used to make tough and easy cuts. Such cutting tools include but are not limited to trimmers, clippers and scissors. Trimmers and clippers are often used to cut plant items but can be used to cut other materials. Scissors are often used to cut non-plant materials but are also not limited to such applications by their users. In those instances where such cutting tools are used repetitively over an extended period of time, such as when trimming herbs, for example, they can be difficult to use without fatigue and pain setting in. It would be preferable to have a cutting tool that can be used for an extended period time while minimizing fatigue and/or pain.

Existing spring-loaded trimmer designs include a spring load which biases two handles of the device to the open position, maintaining contact between the handles and the hand. One handle presses against the inside of the fingers and the other handle presses against the palm of the hand. There is no contact of the tool with the backside of the fingers and/or hand. When the user handles the device, (s)he must maintain contact with both handles or the trimmer will drop out of the hand. The convenience of such a tool is reduced when used over an extended period of time.

Alternatively, the common scissor handle design has ring handles that capture the user's fingers, allowing the user to open his/her hand without dropping the device as a portion of the handle contacts the back side of the hand and/or fingers. The ring handles typically are of rigid and hard material (metal, hard plastic). During extended use, repeated and awkward contact with the ring handles can result in injuries, such as blisters, chafing, bruising, and/or cramping. In addition, because there is no spring bias of the handles, the user of a pair of scissors must apply force for opening and closing, which further accelerates fatigue and pain when used repetitively over an extended period of time.

What is needed is a cutting tool that can be used conveniently over an extended period of time in a repetitive way while minimizing the pain and fatigue associated with using existing spring-loaded trimmers and existing scissors.

### SUMMARY OF THE INVENTION

The present invention is an ergonomic cutting tool that can be used repetitively over an extended period of time with minimal fatigue and/or pain. The invention provides the means to connect the cutting tool handle with a user's 3^{rd} and 4^{th} (middle and ring) fingers, during use. The invention may be of two structural forms: built-in to handle of spring-loaded clippers, or as an add-on component. This invention allows spring-loaded cutting tools, particularly trimmers suitable for cutting herbs such as cannabis but not limited thereto, to be used more dexterously, efficiently and safely.

The invention combines features of trimmers and scissors in a unique way that maintains the comfort and convenience of spring-loaded trimmers while adding the efficiency of connectedness and retention of value in a conventional scissors device. It enables the user to open their hand widely, wide enough to release the palm of their hand from the handle, without dropping the device. This advantage is especially useful in horticultural applications; like plant trimming, since it makes available the user's 1^{st} and 2^{nd} fingers (thumb and index) for other tasks, like manually pinching plant features. The invention makes it possible to alternate between such tasks without requiring the user to put the trimmers down.

The ergonomic cutting tool of the present begins with the configuration of a trimmer in that it includes two opposing hands spring-biased against a closed condition, in which the trimmer configuration is modified to include a flexible member along the length of one or both of the handles, providing a retainer element against the backside of one or more of the user's fingers. The flexible member may contour and/or flex to various hand sizes and positions, capturing two or more fingers (typically the 3^{rd} and 4^{th} fingers). The flexible member is formed of a material that is preferably nonmetallic, such as a rubber or plastic material sufficiently elastic to stretch to allow the user to place his/her finger(s) between it and the handle to which it is joined while it maintains secure contact with the finger(s) once in position on that handle. The flexible member may be a tube of such elastic material that is solid, hollow or hollow with the interior filled with a liquid or a gel that may be selected to enhance comfort. A first end or proximal end of the flexible member is joined to one handle at one end, such as relatively close to the cutting components of the trimmer, and a second end or distal end of the flexible member is joined to that same handle spaced away from the first end such as at or near the end of the handle away from the cutting components. While generally described herein as an ergonomic cutting tool with one flexible member on one handle, it is contemplated that both handles can include a flexible member.

The distal end of the flexible member may be attached to the handle in a folded-over manner that defaults to an open position. When tightened, the flexible member closes on, and applies pressure to, the fingers. A lock and release mechanism may be incorporated to allow the user to set optimal tension for comfort, as well as release the flexible member for easy removal from the hand. The flexible member forms an integral part of the handle to which it is joined, such as during manufacture of the cutting tool. Alternatively, it may be permanently affixed to the handle. An optional feature of the cutting tool is that at least one of the handles includes on an inner surface thereof finger rests or contours that improve the contact and reduce fatigue for the fingers in contact therewith such as the 2^{nd} and 5^{th} fingers.

During typical trimming use, the spring-loaded handles maintain contact with the user's hand. Simultaneously, the flexible member captures two (or more) fingers on the user's hand, typically the 3^{rd} and 4^{th} fingers. This connection between the flexible member, handle, and fingers enables the user to open their hand without dropping the scissors; allowing for intermittent use of non-captured fingers; particularly the thumb and index finger, without the inconvenience of putting down the device.

Some horticulture trimming-related tasks previously unavailable with existing spring-loaded trimmers include, but are not limited to: picking out molded portions of a plant bud, since it is best for the user to encapsulate the molded part in their fingers rather than cut it with a scissors. (The spores may release if cut with the scissor blades.) With this invention, the user can switch from clipping to pinching without setting the trimmers down to do it. This advantage extends to other manual tasks like picking up piles of untrimmed product and snapping stems.

The ergonomic cutting tool may be used for a wide variety of cutting activities and is not limited to use with plants. It is particularly effective for repetitive and/or long-term cutting activities. The inclusion of the flexible member to at least one of the handles on an exterior area thereof helps the user to retain the cutting tool without the need to continue holding the handles. The invention provides convenience of use while minimizing fatigue and pain associated with extended cutting activity. These and other features will be understood upon review of the following detailed description, accompanying drawings and appended claims.

### BRIEF DESCRIPTION OF THE DRAWINGS

FIG. 1 is a side view of the ergonomic cutting tool of the present invention.

FIG. 2 is a side view of an alternative embodiment of the ergonomic cutting tool of the present invention including a flip release end of one handle.

FIG. 3 is an example depiction of a prototype of the invention in position on a user's hand.

FIG. 4 is an example depiction of a prototype of the invention with the optional flip release.

### DETAILED DESCRIPTION OF THE INVENTION

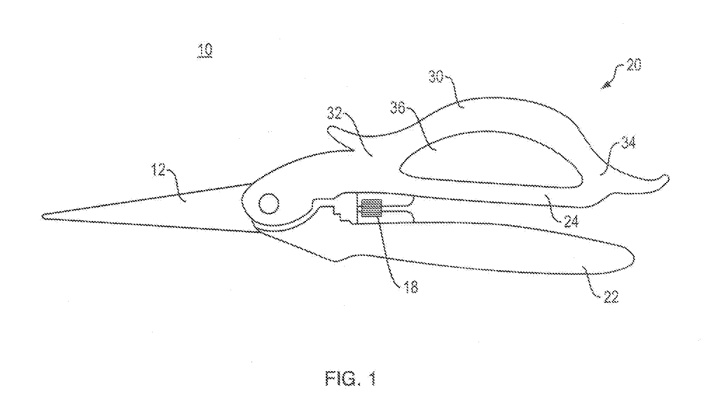

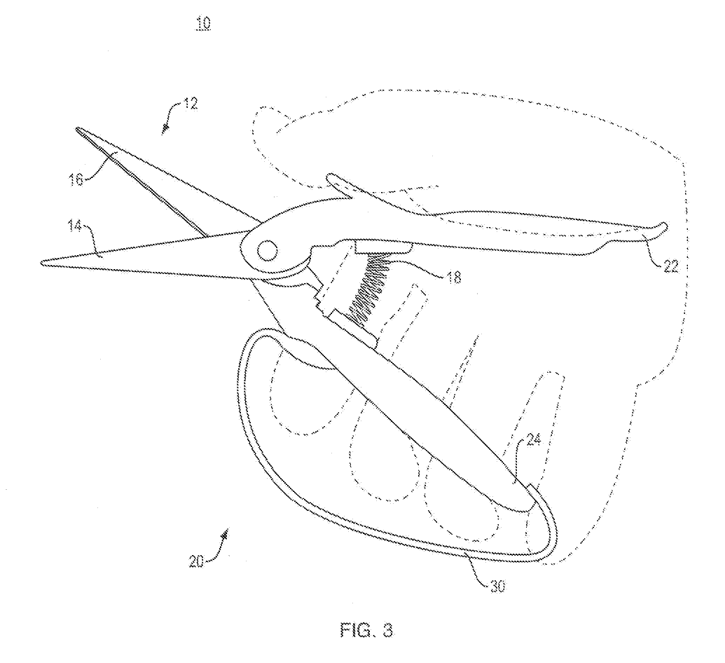

An ergonomic cutting tool 10 is shown in FIGS. 1 and 3. The tool 10 includes a cutting component 12 comprising a first cutting blade 14 and a second cutting blade 16. The cutting component 12 is coupled to a handle component 20 comprising a first handle 22 and a second handle 24. The first handle 22 and the second handle 24 are biased to be spaced from one another by a spring element 18 so that the first cutting blade 14 and the second cutting blade 16 are spaced from one another. When the cutting tool 10 is used, a user squeezes together with one hand the first handle 22 and the second handle 24 to close the cutting component 12, and releases that applied pressure to open the cutting component 12. The cutting tool 10 may be used to clip, cut or trim an array of materials including, but not limited to, plants and plant components.

The cutting tool 10 further includes flexible member 30 having a proximal end 32 and a distal end 34. The flexible member 30 is coupled to an exterior surface of either of the first handle 22 and the second handle 24. The flexible member 30 is formed of a material that is preferably nonmetallic, such as a rubber or plastic material sufficiently elastic to stretch to allow the user to place his/her finger(s) between it and the handle (either or both of the first handle 22 and the second handle 24) of the cutting tool 10 to which it is joined while it maintains secure contact with the finger(s) once in position on that handle. The flexible member 30 may be a tube of such elastic material that is solid, hollow or hollow with the interior filled with a liquid or a gel that may be selected to enhance comfort. The flexible member 30 may be formed integrally with the handle to which it is joined or it may otherwise be a separate component permanently affixed to the handle, wherein the proximal end 32 is located near the spring element 18 area of the handle and the distal end 34 is located near end 26 of the handle. The flexible member 30 is joined to the handle so as to form a space 36 between the exterior surface of the handle and the flexible member between the proximal end 32 and the distal end 34.

During typical trimming use, the spring-loaded handles 22 and 24 maintain contact with the user's hand. Simultaneously, the flexible member 30 captures two (or more) fingers on the user's hand, typically the 3^{rd} and 4^{th} fingers in the space 36. This connection between the flexible member 30, handle 20, and fingers enables the user to open their hand without dropping the tool 10, allowing for intermittent use of non-captured fingers, particularly the thumb and index finger, without the inconvenience of putting down the tool 10.

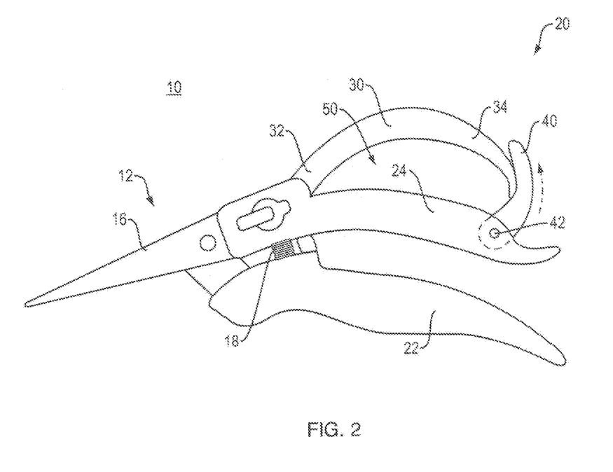

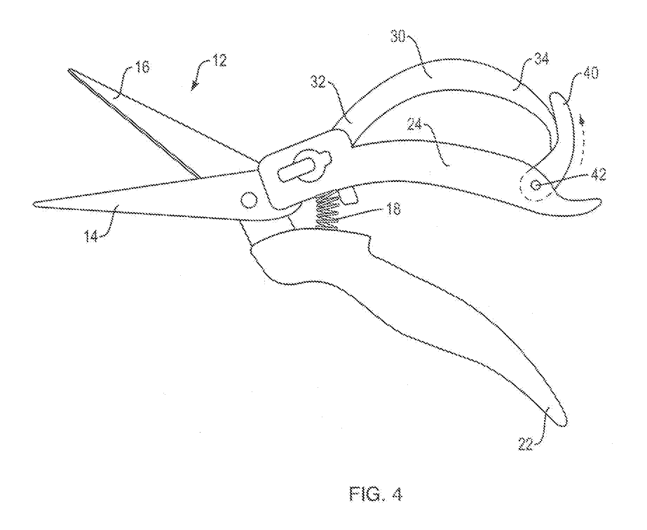

An optional feature of the ergonomic cutting tool 10 is shown in FIGS. 2 and 4. The optional feature is a flip release section 40 of one of the two handles 22 and 24. The flip release section 40 may be hingedly connected to end 28 of either of the two handles 22/24 or it may be pivotably connected to the end with pivot pin 42 shown in FIG. 2. The flip release section 40 can be used to expand area 50 where the user must insert his/her fingers to use the tool 10. That can be of value if the user has larger fingers or is wearer gloves. The expansion of the expanded area 50 occurs when the flip release section 40 is in the up position as shown in the figures. One the fingers are in position on the handle 20, the flip release section 40 may be repositioned so that the pieces of the handle are aligned, thereby resulting in further securing of the flexible member 30 about the user's fingers. Such optional feature is useful when the environment where the cutting occurs is cold or may cause harm to the user's hands, such as when trimming a rose bush, and it is desirable to wear gloves to protect the hands without the need to remove the gloves during the cutting or trimming activity.

The present invention has been described with respect to specific embodiments. The invention is not limited thereto and covers reasonable equivalents in view of the following appended claims.

What is claimed is:

1. An ergonomic cutting tool comprising:
a. a cutting component;
b. a handle component joined to the cutting component, the handle component including a first handle and a second handle;
c. a spring component coupled to the handle component and arranged to bias the handle component to an open position; and
d. a flexible member joined to an exterior surface of either of the first handle and the second handle to form a space therebetween, wherein the flexible member is arranged to enable removable retention of one or more of a user's fingers between the flexible member and the handle to which it is joined.

2. The ergonomic cutting tool of claim 1 wherein the flexible member forms an integral part of the exterior surface of the handle to which it is joined.

3. The ergonomic cutting tool of claim 1 wherein the handle to which the flexible member is joined includes a flip release section arranged to enable expansion of the space between the flexible member and the exterior surface of the handle to which it is joined.
